(19) United States
(12) Patent Application Publication
(10) Pub. No.: US 2014/0245221 A1
(43) Pub. Date: Aug. 28, 2014

(54) Intelligent Scrolling In Digital Publications

(71) Applicant: APPLE INC., Cupertino, CA (US)

(72) Inventors: Casey Maureen Dougherty, San Francisco, CA (US); Kyle T. Howarth, Cupertino, CA (US); Policarpo B. Wood, San Jose, CA (US)

(73) Assignee: Apple Inc., Cupertino, CA (US)

(21) Appl. No.: 13/776,336

(22) Filed: Feb. 25, 2013

(51) Int. Cl. G06F 3/0485

(52) U.S. Cl. CPC G06F 3/0485
USPC 715/787

(57) ABSTRACT

Processing an electronic publication containing content having two different scrolling directions so that the content can be presented to the user through an intelligent unidirectional scrolling function that prevents fragments of sentences from being displayed. Processing can include paginating or generating a scrollable table for portions of the electronic publication that do not match a first text direction.

### TECHNICAL FIELD

The present technology pertains to displaying electronic publications, and more specifically pertains to providing intelligent scrolling during the presentation of electronic publications on a display.

### BACKGROUND

Recent advances in technology have led to the popularity of portable electronic devices such as smart phones, tablets, and portable PCs. The popularity of portable electronic devices has led to an increase in the consumption of media (such as newspapers, magazines, books, and other publications) digitally rather than in traditional print. Digital publications can be processed by a media playback application and presented to the user on an electronic device.

Generally, the media playback application can process the digital publication into pages and allow the user to flip through the pages like a traditional book. In other examples, the media playback application can employ a scroll bar to allow the user to continuously scroll through the contents of the digital publication. An example of this is illustrated in FIG. 1.

FIG. 1 illustrates an example of a system including a digital publication and an electronic device. System 100 includes electronic device 110 and digital publication 120. A processor on electronic device 110 prepares digital publication 120 for presentation on display 115. Presentation can begin at the start flag of the digital publication and end at the end flag of the digital publication. Digital publication 120 has mixed text directions (i.e., content that is to be read from different text directions such as horizontal left to right, horizontal right to left, or vertical) and includes images 125 and 127. Portions 122 and 126 has content that is read horizontally from left to right (e.g., English language) while portion 124 has content that is read vertically from top to bottom (e.g., Chinese or Japanese language). Screen shots 152, 154, and 156 illustrate three problems of what would be shown on display 115 when scrolling stops at that part of the digital publication.

As shown in screen shots 152, 154, and 156, a problem arises when the scroll direction conflicts with the content direction. This is due to the fact that the natural scroll direction for vertical content would be left to right or right to left. At screen shot 152, fragments of a sentence from the vertical sentences of portion 124 are shown on the display. These fragments of sentences make little sense since parts of the sentences are not displayed This is the same at screen shot 156 when the content transitions from vertical content to horizontal content. At screen shot 154, the scrolling has stopped in between pages of vertical content. Since there are no complete sentences on the screen, a user can make little sense from the content displayed on the screen. Thus, there is a need for improved techniques to present digital publications on an electronic device.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for providing intelligent scrolling to electronic publications. A portion of the digital publication can be detected or identified as not matching a dominant text direction of the digital publication. Alternatively, a portion of the digital publication can be detected or identified as having a different scrolling direction as another portion of the digital publication. This detection or identification can occur while the digital publication is being consumed (e.g., read) by a user. For example, a buffer of upcoming content can be filled based on on a current position that identifies the portion of the digital publication being displayed on the client device. As the user scrolls through the contents of the digital publication, the current position can be updated and so can the buffer. The buffer can be analyzed to detect or identify content that is not in the dominant text direction.

In one embodiment, a processor can enable scrolling in a preferred scroll direction of the identified content. Therefore, the scroll direction can change as the user scrolls through the digital publication.

In another embodiment, the processor can generate a scrollable table to present the identified content. The scrollable table can be generated when the scrolling direction of the identified content differs from another portion of the digital publication. The scrollable table can receive touch gestures or user inputs to scroll the identified content in its preferred scroll direction. The scrollable table can be presented in the place of the identified content. When scrolling stops within the identified content, the scrollable table can frame the scrollable table to the display area such that the entire scrollable table is presented on the display area. Scrolling through the identified content can occur in the preferred scroll direction. Once the user has finished consuming the identified content, the user may resume scrolling through the remainder of the digital publication. In one example, the user can resume scrolling in the default scroll direction of the digital publication.

In yet another embodiment, the processor can paginate the identified content. Paginating the identified content can include reformatting the identified content such that the identified content can fit into one or more pages. The one or more pages can be configured for presentation on a display area of the client device. The one or more pages can further be configured to snap to the display area when a majority of the page is presented on the display area.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system including a digital publication and an electronic device;

FIG. 2 illustrates an exemplary scroll path of a digital publication;

FIG. 3 illustrates an example of processing a digital publication;

FIG. 4 illustrates another exemplary scroll path;

FIG. 5 illustrates another example of processing a digital publication;

FIG. 6 illustrates another exemplary scroll path;

FIG. 7 illustrates an exemplary process for processing a digital publication;

FIG. 8 illustrates another exemplary process for processing a digital publication;

FIG. 9 illustrates another exemplary process for processing a digital publication;

FIG. 10 illustrates a conventional system bus computing system architecture; and

FIG. 11 illustrates a computer system 1000 having a chipset architecture that can be used in executing the described method and generating and displaying a graphical user interface (GUI).

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for systems, devices, techniques, and methods for providing intelligent scrolling during the presentation of digital publications containing mixed text directions. A digital publication is defined as containing mixed text directions when the content of the digital publication includes text having different writing progression direction. Each language has a writing progression direction that specifies the writing (and reading) direction of the language. For example, the English language is meant to be written horizontal left to right, top to bottom. As another example, the Chinese language is meant to be written vertical top to bottom, left to right. Some languages can have multiple writing progression directions. For example, Japanese can be written vertically right to left or horizontally left to right. Thus, a digital publication having both English and Chinese writing is considered a mixed text directions digital publication. However, a digital publication having both English and Spanish (another language that is written horizontal left to right, top to bottom) is not considered a mixed text directions digital publication since the writing progression direction of the two languages are the same. Examples of mixed text directions digital publications include translation dictionaries and publications for learning a second language.

The following figures describe techniques to improve the presentation of a mixed text directions digital publication. The techniques can be implemented in software or hardware and executed on the client side by a processor of an electronic device or on the server side by a processor that is part of a distribution service. The techniques can include using a variable called dominant text direction which signifies the writing progression direction that is dominant in the digital publication. The techniques can be applied to the contents of the digital publication on a chapter basis, page basis, or word basis. The dominant text direction variable can be defined as metadata on the digital publication or be determined according to the contents of the digital publication.

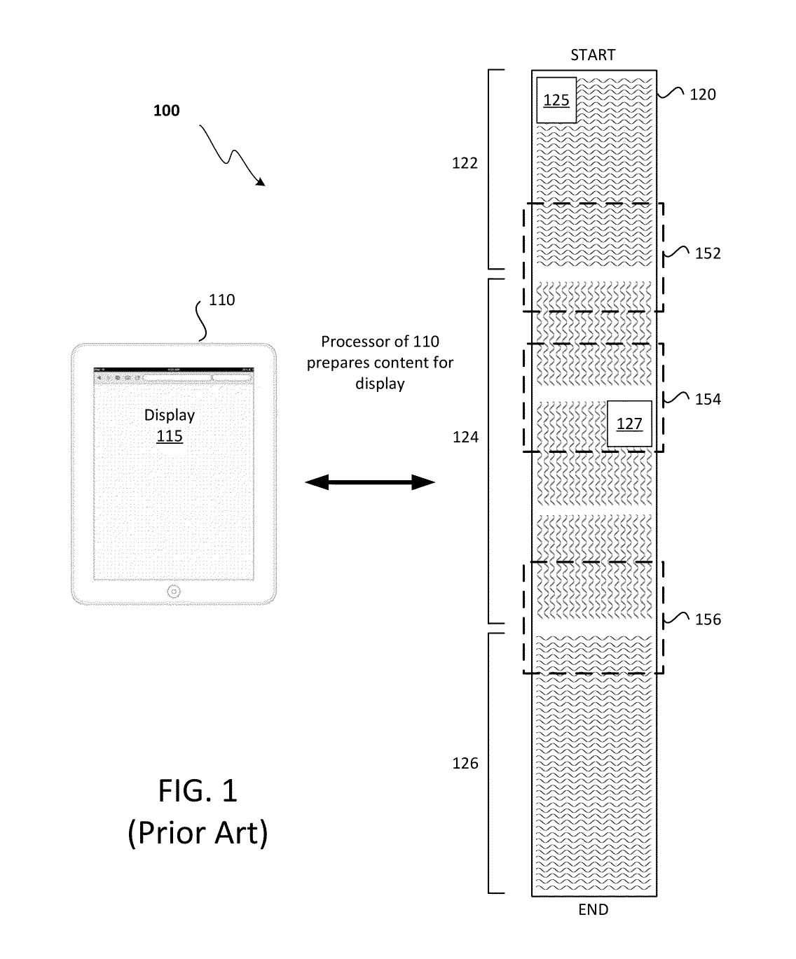

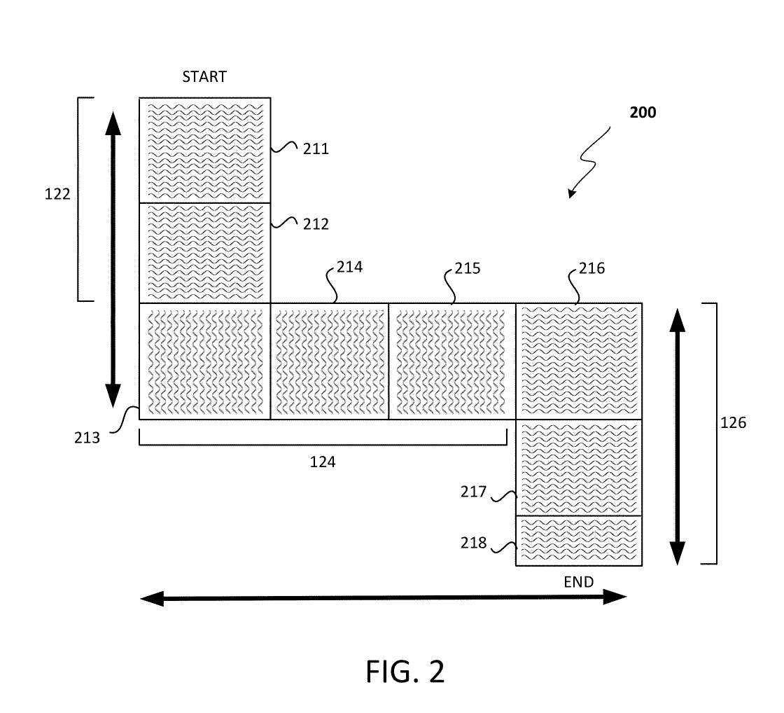

FIG. 2 illustrates an exemplary scroll path of a digital publication. Scroll path 200 can be generated dynamically by a client device as the viewer scrolls through the contents of the digital publication. Alternatively, scroll path 200 can be generated during the processing of a digital publication. The processing can be performed by a client device when the client device receives the digital publication from a distribution service or when a media playback application opens the digital publication. Alternatively, the processing can be performed by a server of a distribution service when the digital publication is received for publication. Scroll path 200 can be generated from digital publication 100 of FIG. 1. As shown, the content is read horizontally left to right for portions 211-212, vertically top to bottom for portions 213-215, and horizontally left to right for portions 216 and 218.

Scroll path 200 illustrates changes in the scrolling direction as the viewer scrolls through the content of the digital publication. Scrolling through the digital publication can transition from vertical scrolling to horizontal scrolling based on changes to the writing progression direction or the content's preferred scroll direction. In some examples, a digital publication can have a default scrolling direction in one direction. The default scrolling direction can be horizontal, vertical, or other direction.

In one embodiment, the scroll direction can change when the writing progression direction changes. For example, the scroll direction can change from vertical scrolling to horizontal scrolling as the writing progression direction changes at the boundary in between portion 212 and portion 213. In some examples, the preferred scrolling direction for content can be perpendicular to the writing progression direction. For instance, the preferred scrolling direction for content that is written horizontal would be vertical scrolling while the preferred scrolling direction for content that is written vertical would be horizontal scrolling.

In another embodiment, scrolling can remain in the same direction for a portion of content after a change in the writing progression direction is detected. As shown in FIG. 2, the vertical scroll direction can continue to the end of portion 213 before the scroll direction changes to horizontal scrolling. By allowing scrolling to remain in the same direction when the writing progression direction initially changes, a user can consume (e.g., read) some content in the new writing progression direction before a change to the scroll direction occurs. This can be useful for informing a user of an upcoming change to the scroll direction before the change takes place. In one example, the media playback application can be configured to display an entire screen of content in the new writing progression direction before changing the scroll direction.

Here, scroll path 200 begins with vertical scrolling for portions 211-213 of the digital publication. Scroll path 200 transitions to horizontal scrolling for portions 213-216 of the digital publication when vertical scrolling has reached the end of portion 213. Later, scroll path 200 transitions back to vertical scrolling for portions 216-218 of the digital publication once horizontal scrolling has reached the end of portion 216. During the transition, scrolling for a portion of the digital publication can scroll in one direction and then another. For example, the user can vertically scroll through portion 213 from portion 212. Once the bottom edge of portion 213 is reached from vertical scrolling, scrolling transitions to horizontal scrolling where the user can horizontally scroll through portion 213 to portion 214. In some examples, the media playback application can perform a bounce back operation when the user reaches the end of a scrolling direction to notify the user that scrolling is transitioning to another direction. For instance if the user attempts to vertically scroll past the bottom edge of portion 213, a bounce back operation can be performed where the bottom edge of portion 213 is lined up with the bottom edge of the display. The bounce back operation can serve to notify the user that the end of the vertical scrolling has been reached and/or that the scrolling direction has changed.

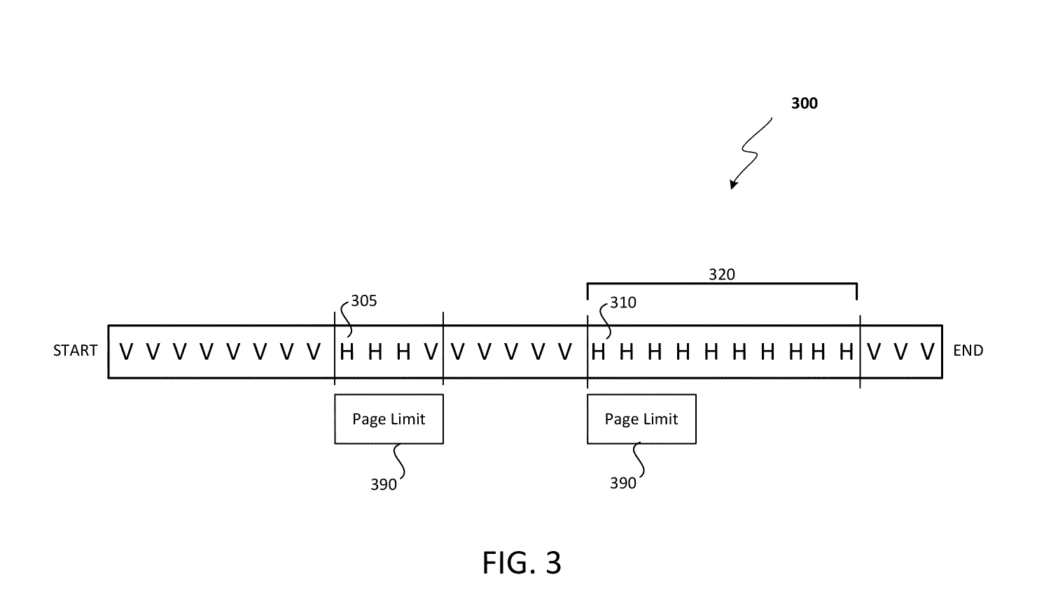

In some embodiments, techniques for processing a digital publication can take into consideration the display resolution of the client device. Depending on the display resolution, the display area reserved for the presentation of the digital publication, and the desired text size/font for presentation, a determination can be made as to how much content can be presented on the display at a given point in time. The amount of content that can be presented on the device at one time can be stored as a variable known as the page limit. The techniques described below in FIGS. 3-5 utilize the page limit variable in creating an intelligent scroll path for the user.

FIG. 3 illustrates an example of processing a digital publication. Digital publication 300 has a start and an end at opposite sides of the digital publication. Each “H” in digital publication 300 represents a unit of content that is written horizontally and each “V” in digital publication 300 represents a unit of content that is written vertically. Each unit of content can be a chapter, a page, a paragraph, or a predefined number of characters words. An example of a unit of content that is written vertically would be Chinese while an example of a unit of content that is written horizontally would be English.

A dominant text direction can be defined for the digital publication. The definition can be defined in the digital publication or alternatively determined by analyzing the digital publication. For example, a processor can determine the dominant text direction of the digital publication is vertical when the majority of the content is vertical. As another example, the dominant text direction of the digital publication can be manually defined by the author, publisher, or distributor. Portions of content that are not in the dominant text direction can be identified through metadata or flags that are associated with the portions of content. In some examples, the default scrolling direction can be set based on the dominant text direction. The default scrolling direction can be defined in the digital publication, by the processor, or determined by the media playback application. Here, the default scrolling direction is horizontal and the dominant text direction is vertical.

In one example, a page progression direction field can be used to determine the default scrolling direction. The page progression direction field can define the direction in which the pages of the digital media item flip in the digital publication. For example, the page progression direction field for a traditional English book would be set to “right to left” since the pages in the book flip from the right to the left. The page progression direction can be “right to left,” “left to right,” “top to bottom,” “bottom to top,” or other directions. The value stored in the page progression direction field can affect the scroll direction when the digital publication is presented on a client device. For example, a digital publication that has a page progression direction of right to left can be presented as a traditional publication where the pages flip from right to left.

In another example, a writing mode field can be used to determine the default scrolling direction. For example, the Chinese language can be presented as the modern horizontal writing or the traditional vertical writing. The writing mode field can be used when the digital publication is processed to determine the default scrolling direction or the dominant text direction. In some examples, the text direction can be inferred from the writing mode field and the language.

In another example, a primary language field can be used to determine the default scrolling direction. The primary language field can specify the primary language of the digital media item. For example, the primary language field can be English for an electronic book for teaching an English speaker the Japanese language.

These fields along with the default scrolling direction and the dominant text direction can be set by one or more of the author, the publisher or the distributor. In some examples, a hierarchy can exist where a variable set by a distributor cannot be overridden by a publisher. Similarly, a variable set by a publisher cannot be overridden by the author. In other examples, a copy of one or more of these other variables can be stored for each part on the digital media item. For instance, a digital media item can have a writing mode field for the author, the publisher, and the distributor. A hierarchy can exist between the parties such that a particular writing mode field is used during processing of the digital media item.

A processor can process the digital publication by iterating through the contents of a digital publication. The processor can preprocess the digital publication before it is consumed (e.g., read) or alternatively process a buffer of the digital publication as the digital publication is being consumed. For example, the processor can process the next 50 lines of text while a current line of text is being consumed. When content is detected having a preferred scrolling direction that is not the default scrolling direction (and therefore the content has a different writing direction than the dominant text direction), a determination can be made whether there is enough continuous content in the preferred scrolling direction to occupy the entire display area. This can be determined by using the page limit variable. If there is enough continuous content in the preferred scrolling direction to occupy the display area, the processor can set the continuous content as being scrollable in the preferred scrolling direction. The media playback application can allow the user to scroll in the preferred scrolling direction for the portion of continuous content according to the setting. Here, the processor can detect that text written horizontally is at 305. However, the horizontally written text is less than the page limit variable 390. As such, the text written horizontally retains horizontal scrolling. In other examples, metadata for portions of text having a preferred scrolling direction that is not the default scrolling direction can be set to allow the portions of text to be scrolled in the preferred scrolling direction irrespective of the page limit variable. Thus, the text written horizontally at 305 would be able to be vertically scrolled in those examples.

When horizontal text is detected at 310, a determination is made that the portion of continuous text in the horizontal direction is enough to cover the page limit variable 390. In response to the determination, metadata can be set for the portion of continuous text 320 to be scrolled in the preferred scroll direction of the content (e.g., vertically scrolled). In some examples, the portion of continuous text can be presented with margins to section off the portion of continuous text 320 so that it can be easily identifiable to the user during scrolling. A media playback application can be configured such that when scrolling stops, the media playback application properly frames a page such that margins are positioned along the edge of the display area. Therefore scrolling to a point in the digital publication where the margin is on the display area but not on the edge can result in the media playback application properly framing the digital publication. Properly framing content in the digital publication can include ensuring that the margins appear along the edge of the display. This results in words not being cut off at the end of a sentence. In another example, the portion of continuous text can be replaced with a scrollable table during presentation of the portion of continuous text. The scrollable table can include selectable icons to navigate or control scrolling in the preferred direction. Alternatively, the scrollable table can receive touch gestures to scroll through the portion of continuous text in the preferred direction. In this scenario, the scrollable table can include icons to indicate the direction of navigation. These icons can inform the user that the scrollable table can be scrolled via touch gestures in the preferred direction.

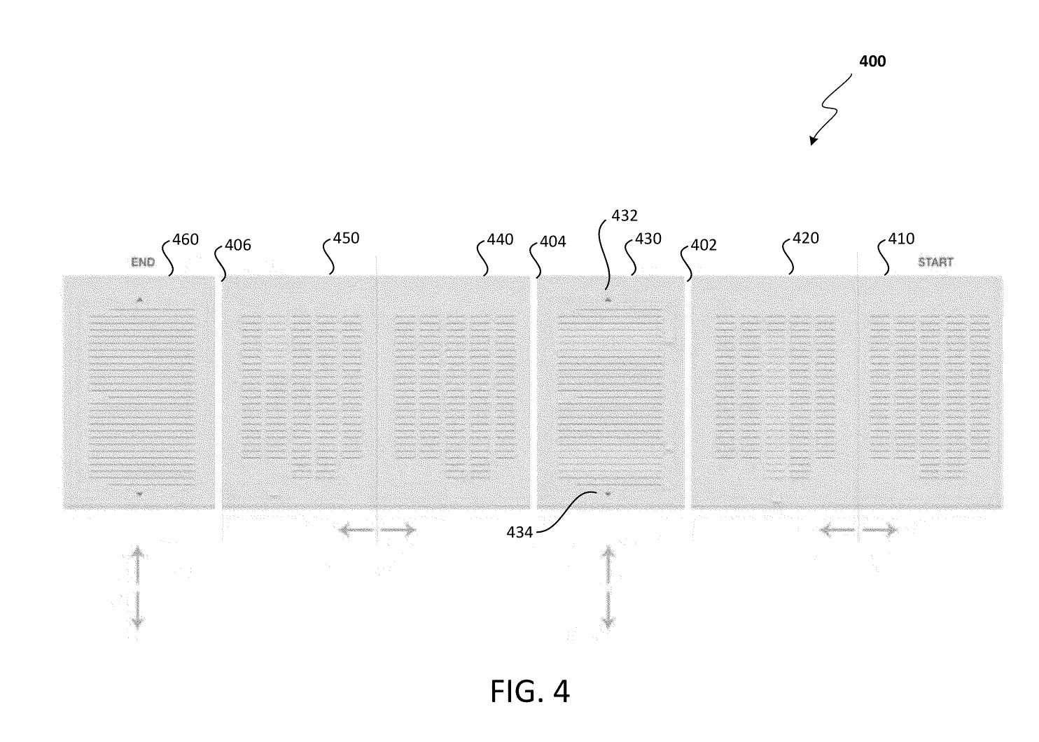

FIG. 4 illustrates another exemplary scroll path. As shown, scroll path 400 starts at one end and ends at another end Portions of the digital publication have been highlighted as shown in scroll path 400. Scroll path 400 includes a plurality of portions. Portions 410, 420, 440, and 450 include language having a vertical progression direction while portions 430 and 460 include language having a horizontal progression direction.

Scroll path 400 can begin with horizontal scrolling for a portion of the digital publication containing language that is to be horizontally scrolled (portion 410 and 420). The scroll direction of the portion of content can be determined by evaluating the content, which can include checking metadata associated with the portion of content. Alternatively the scroll direction can be determined by determining the language of the portion and looking up the preferred scrolling direction of the language in a table. Once scrolling encounters a portion of scroll path 400 that is meant to be vertically scrolled (portion 430), a scrollable table can be presented as a page on the display area. The content can be inset within the scrollable table. In some examples, icons or scroll bars can be presented to allow a user to scroll in the preferred scroll direction of the content. For example, icons 432 and 434 can be presented to allow a user to vertically scroll through the content. In other examples, a touch screen interface can be used to vertically scroll through the content. In some examples, margins 402 and 404 can also be presented to notify the user that scrolling has transitioned from horizontal scrolling to vertical scrolling. The margins can also be gaps or page breaks. In some examples the presentation of the content within the scrollable table can be formatted according to the resolution of the display area and the desired text size.

Once it is detected that vertical scrolling has passed portion 432, the scroll path can transition to scrolling horizontally at portion 440. The transition from vertical to horizontal can include removing the scrollable table and margins 402 and 404. Horizontal scrolling can continue through portions 440 and 450 until it is detected that scrolling has passed portion 450. At this point, the scroll path can transition to vertical scrolling and a scrollable table can be presented with margin 406 for vertical scrolling. In some examples, snapping behavior can be implemented to align the scrollable table on the display area.

In another embodiment, portions of the digital publication containing a language with a preferred scroll direction that does not match the default scrolling direction can be paginated instead of being inserted into a scrollable table. Paginating a portion of the digital publication includes reformatting the content to fit on multiple pages, where each page can be presented in the display area. The pages can include margins like in a traditional book. When scrolling stops at a paginated portion of the digital publication, the media playback application can snap to a page that is closest to the stopping point. This can prevent a scrolling scenario where scrolling stops at a point in the digital publication where fragments of content from different paragraphs are presented on the display area.

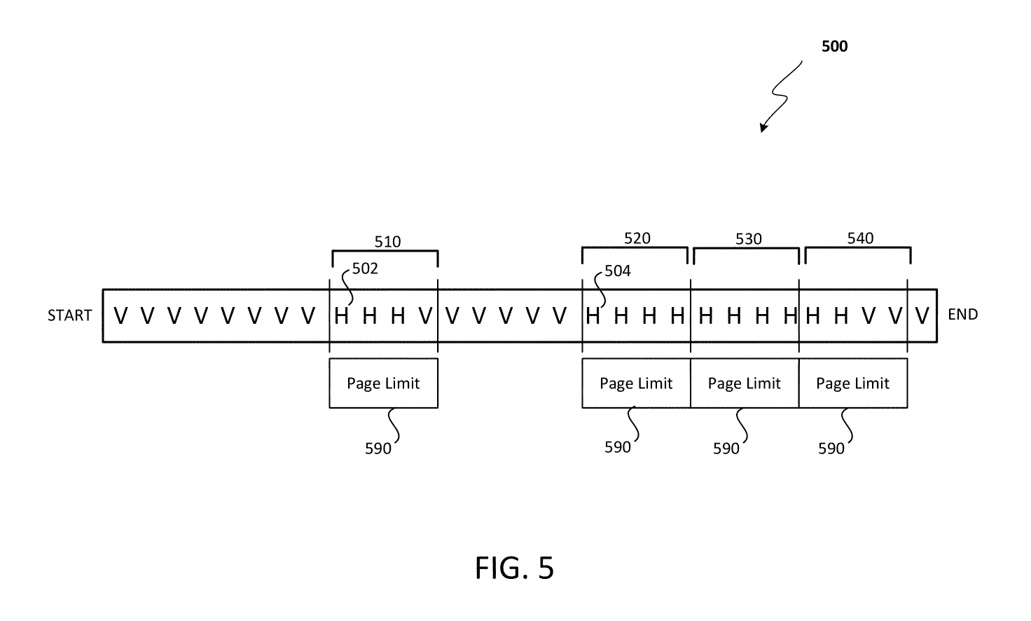

FIG. 5 illustrates another example of processing a digital publication. Digital publication 500 has a start and an end at opposite sides of the digital publication. Similar to the digital publication of FIG. 3, each “H” in digital publication 300 represents a unit of content that is written horizontally and each “V” in digital publication 300 represents a unit of content that is written vertically. A processor can set the dominant text direction of the digital publication to vertical since the majority of the content is vertical. Alternatively, the dominant text direction of the digital publication can be manually set. Portions of content that are not in the dominant text direction can be identified through metadata or flags that are associated with the portions of content. In some examples, the default scrolling direction can be set based on the dominant text direction. Here, the default scrolling direction is horizontal since the dominant text direction is vertical.

A processor can process the digital publication by iterating through the contents of a digital publication. Preprocessing the digital publication can occur before it is consumed (e.g., read) or while the digital publication is being consumed. For example, the processor can process the next 50 lines of text while a current line of text is being consumed. When content is detected having a preferred scrolling direction that is not the default scrolling direction, the processor can paginate the content. Here, the processor detects a change to horizontal text at 502 and generates page 510 according to the page limit variable 590. The page generated can include some vertical text if the portion of horizontal text is insufficient to fill the entire page. After generating page 520, the processor detects a return to the dominant text direction and thus stops paginating content. When the processor detects a change to horizontal text again at 520, the processor can paginate the content. Here, pages 520, 530, and 540 are generated according to the page limit variable 590. In another example, pagination may not occur unless there is an entire page of content in the non-dominant text direction. For instance, pages 510 and 540 would not be generated since they do not include an entire page of content in the non-dominant text direction.

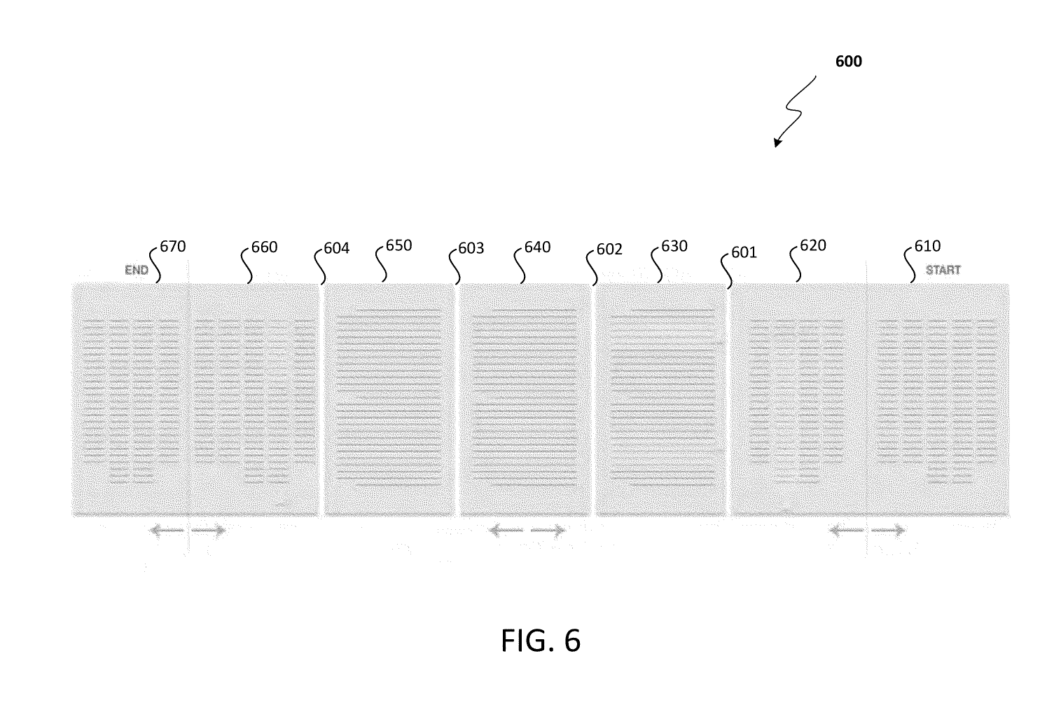

FIG. 6 illustrates another exemplary scroll path. As shown, scroll path 600 starts on the right and ends at the left. Scroll path 600 is also unidirectional. The default scrolling direction is horizontal and more specifically right to left. Portions of the digital publication have been highlighted as shown in scroll path 600. Scroll path 600 includes a plurality of portions. Portions 610, 620, 660, and 670 include language having a vertical progression direction while portions 640, 640, and 650 include language having a horizontal progression direction.

Scroll path 600 can begin with horizontal scrolling for a portion of the digital publication containing language that is to be horizontally scrolled (portion 610 and 620). This can be determined by evaluating the content, which can include checking metadata associated with the portion of content or by determining the language of the portion and looking up the preferred scrolling direction for the language in a table. Once scrolling encounters a portion of scroll path 600 that has been paginated (portions 630, 640, and 650), the portion can be presented as pages on the display area. Margins 601-604 can be included to separate the pages from one another. In one example, scroll path 400 can snap to a page when scrolling stops in between pages. Snapping can result in one page being In another example, the presentation of the content on the pages can be formatted according to the resolution of the display area and the desired text size. In some examples, specific elements in the digital publication such as the title page, the credits, the table of contents, and other sections of the digital publication can be set to a writing progression direction or a scrolling direction. Once the user scrolls past portion 650, the writing progression direction of portions 660 and 670 returns to the dominant text direction of the digital publication and the content can be continuously scrolled in the horizontal direction without pagination or snapping behavior.

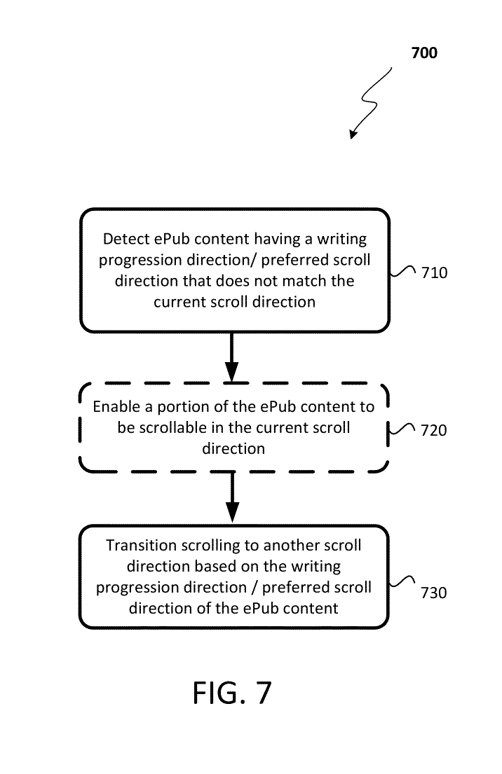

FIGS. 7-9 disclose methods for processing a digital publication. The methods can be performed by a client device when a book is loaded on the client device, when a book is first downloaded on the client device, or in real time by processing a buffer of upcoming content in the digital publication. The methods can also be performed by a server to prepare the digital publication for publication. If performed by the server, different versions of the digital publication can be generated for different client devices having different screen resolutions and screen sizes.

FIG. 7 illustrates an exemplary process for processing a digital publication. Process 700 begins by detecting digital publication content having a writing progression direction or preferred scroll direction that does not match the current scroll direction at 710. The writing progression direction or preferred scroll direction of the digital publication content can be stored as metadata of the digital publication content. The mismatch can be detected as scrolling instructions are being received during navigation through the digital publication. Alternatively, the mismatch can be detected during preprocessing of the digital publication by a client or as server. Once the mismatch has been detected, process 700 can optionally enable a portion of the digital publication content to be scrollable in the current scroll direction. The portion of the digital publication content can be digital publication content that is sufficient to fill the display area of the client device. This can allow a user to view a page of the mismatched digital publication content using the current scroll direction. Once the portion of the digital publication content has been scrolled through, process 700 can transition scrolling to another scroll direction based on the writing progression direction or preferred scroll direction of the digital publication content at 730. The new scroll direction can apply to the remainder of the digital publication content. During the transition, a bounce back feature can be used to notify the user that the scroll direction has changed. The bounce back feature can snap the digital publication back to the portion of the digital publication content when an attempt is made to scroll past the transition point (the point where scrolling transitions from the current direction to another direction).

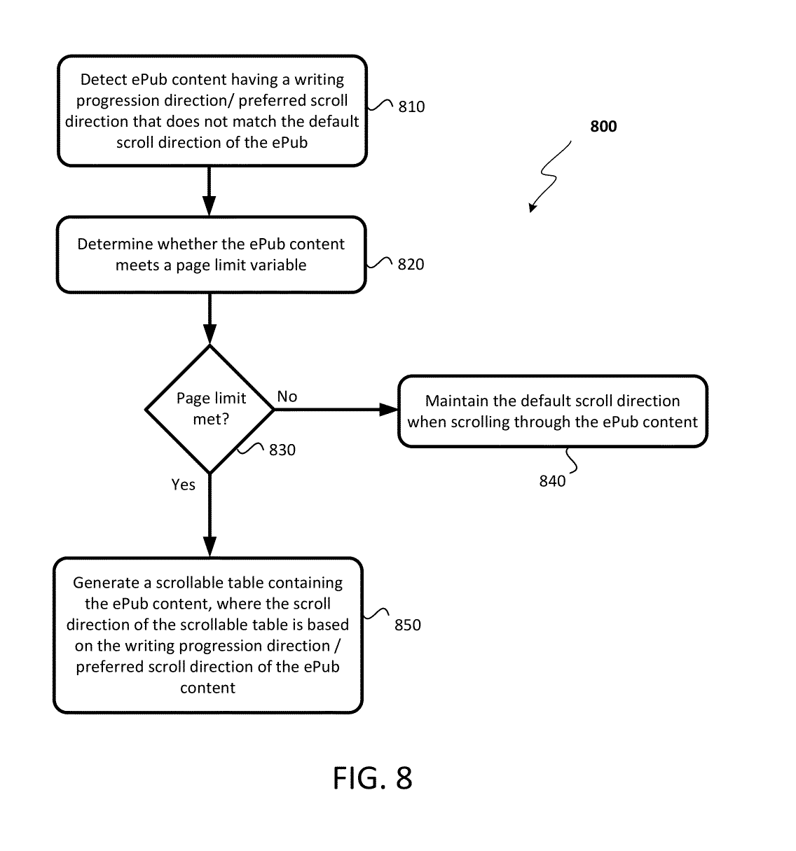

FIG. 8 illustrates another exemplary process for processing a digital publication. Process 800 begins by detecting digital publication content having a writing progression direction or preferred scroll direction that does not match the default scroll direction of the digital publication at 810. The default scroll direction of the digital publication can be based on the dominant text direction of the digital publication. Once the mismatch has been detected, process 800 can determine whether the digital publication content meets a page limit variable at 820. The page limit variable can be associated with the client device as the amount of content that can be displayed on the display area of the client device at a given point in time. The digital publication content can meet or exceed the page limit variable when the digital publication content available is sufficient to fill the entire display area. If the page limit is not met at 830, process 800 can maintain the default scroll direction when scrolling through the digital publication content at 840. Therefore, the scroll direction for the digital publication content will not be its preferred scroll direction. Alternatively if the page limit is met at 830, process 800 can generate a scrollable table containing the digital publication content, where the scroll direction of the scrollable table is based on the writing progression direction or preferred scroll direction of the digital publication content at 850. The scrollable table can include scroll icons for scrolling in the preferred scroll direction and margins to identify the scroll table. In some examples, the scroll table can snap into place (e.g., be framed in the display area) when scrolling stops and a majority of the scroll table is presented on the display area or when scrolling stops within the digital publication content. In another example, step 850 can be replaced with 730 and optionally 720 of FIG. 7. In yet other examples, process 800 can generate a scrollable table in response to detecting a mismatch in the writing progression direction of the portions of the digital publication content.

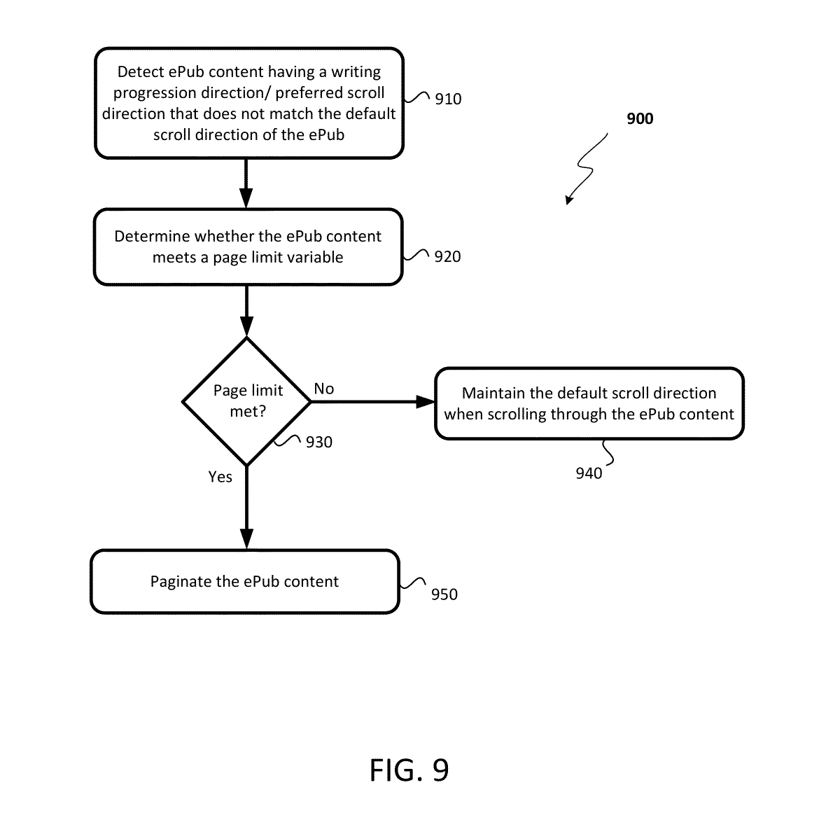

FIG. 9 illustrates another exemplary process for processing a digital publication. Process 900 begins by detecting digital publication content having a writing progression direction or preferred scroll direction that does not match the default scroll direction of the digital publication at 810. Once the mismatch has been detected, process 900 can determine whether the digital publication content meets a page limit variable at 920. The page limit variable can be associated with the client device to dictate the amount of content that can be displayed on the display area of the client device at a point in time. The digital publication content can meet the page limit variable when the digital publication content available is sufficient to fill the display area. If the page limit is not met at 930, process 900 can maintain the default scroll direction when scrolling through the digital publication content at 940. Therefore, the scroll direction for the digital publication content will not be its preferred scroll direction. Alternatively if the page limit is met at 930, process 900 can paginate the digital publication content at 950. Pagination can include reformatting the digital publication content to be presented as pages on the display area. Pagination can also include providing margins and snap functionality to ensure that a single entire page is presented on the display area when scrolling has stopped. In one example, pagination can alter the digital publication file. In another example, pagination can alter the presentation of the digital publication without altering the digital publication. In yet another example, step 910 can continue to step 950 without making the determination described in step 920 and 930. This can result in the pagination of all instances of digital publication content that does not match the default scroll direction of the digital publication. In yet another example, a user-defined variable can be used instead of the page limit variable.

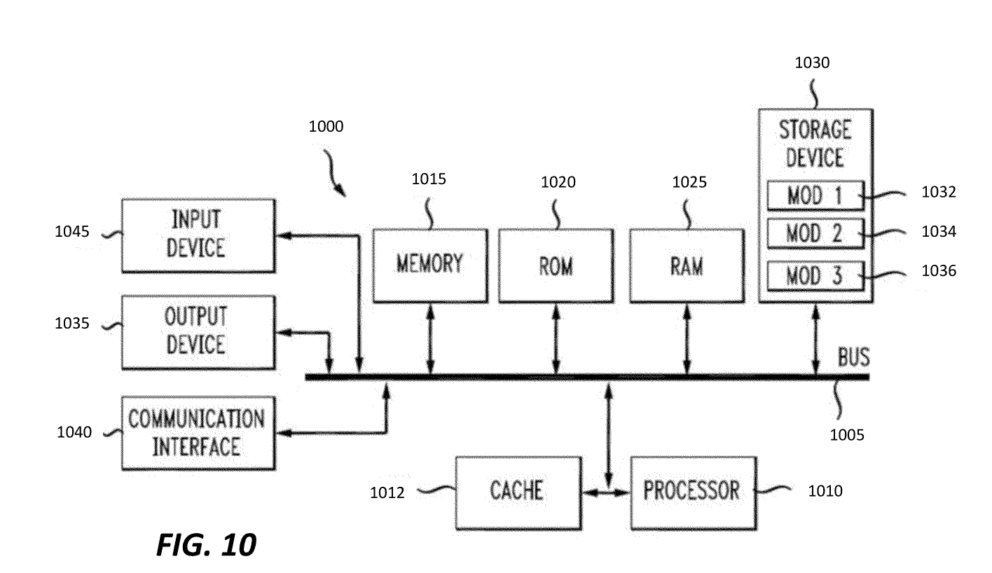

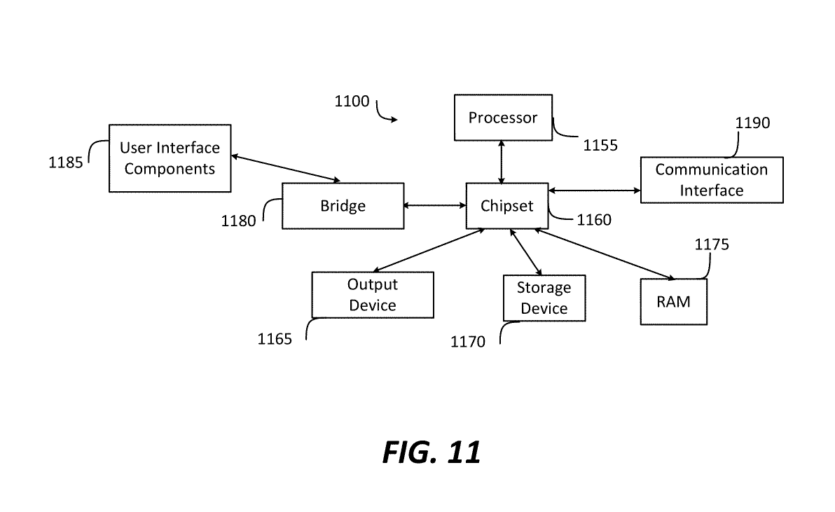

FIG. 10 and FIG. 11 illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 10 illustrates a conventional system bus computing system architecture 1000 wherein the components of the system are in electrical communication with each other using a bus 1005. Exemplary system 1000 includes a processing unit (CPU or processor) 1010 and a system bus 1005 that couples various system components including the system memory 1015, such as read only memory (ROM) 1020 and random access memory (RAM) 1025, to the processor 1010. The system 1000 can include a cache of high-speed memory connected directly with, in close proximity to, or integrated as part of the processor 1010. The system 1000 can copy data from the memory 1015 and/or the storage device 1030 to the cache 1012 for quick access by the processor 1010. In this way, the cache can provide a performance boost that avoids processor 1010 delays while waiting for data. These and other modules can control or be configured to control the processor 1010 to perform various actions. Other system memory 1015 may be available for use as well. The memory 1015 can include multiple different types of memory with different performance characteristics. The processor 1010 can include any general purpose processor and a hardware module or software module, such as module 1 1032, module 2 1034, and module 3 1036 stored in storage device 1030, configured to control the processor 1010 as well as a special-purpose processor where software instructions are incorporated into the actual processor design. The processor 1010 may essentially be a completely self-contained computing system, containing multiple cores or processors, a bus, memory controller, cache, etc. A multi-core processor may be symmetric or asymmetric.

To enable user interaction with the computing device 1000, an input device 1045 can represent any number of input mechanisms, such as a microphone for speech, a touch-sensitive screen for gesture or graphical input, keyboard, mouse, motion input, speech and so forth. An output device 1035 can also be one or more of a number of output mechanisms known to those of skill in the art. In some instances, multimodal systems can enable a user to provide multiple types of input to communicate with the computing device 1000. The communications interface 1040 can generally govern and manage the user input and system output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof.

The storage device 1030 can include software modules 1032, 1034, 1036 for controlling the processor 1010. Other hardware or software modules are contemplated. The storage device 1030 can be connected to the system bus 1005. In one aspect, a hardware module that performs a particular function can include the software component stored in a computer-readable medium in connection with the necessary hardware components, such as the processor 1010, bus 1005, display 1035, and so forth, to carry out the function.

FIG. 11 illustrates a computer system 1100 having a chipset architecture that can be used in executing the described method and generating and displaying a graphical user interface (GUI). Computer system 1100 is an example of computer hardware, software, and firmware that can be used to implement the disclosed technology. System 1100 can include a processor 1155, representative of any number of physically and/or logically distinct resources capable of executing software, firmware, and hardware configured to perform identified computations. Processor 1155 can communicate with a chipset 1160 that can control input to and output from processor 1155. In this example, chipset 1160 outputs information to output 1165, such as a display, and can read and write information to storage device 1170, which can include magnetic media, and solid state media, for example. Chipset 1160 can also read data from and write data to RAM 1175. A bridge 1180 for interfacing with a variety of user interface components 1185 can be provided for interfacing with chipset 1160. Such user interface components 1185 can include a keyboard, a microphone, touch detection and processing circuitry, a pointing device, such as a mouse, and so on. In general, inputs to system 1150 can come from any of a variety of sources, machine generated and/or human generated.

Chipset 1160 can also interface with one or more communication interfaces 1190 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 1155 analyzing data stored in storage 1170 or 1175. Further, the machine can receive inputs from a user via user interface components 1185 and execute appropriate functions, such as browsing functions by interpreting these inputs using processor 1155.

It can be appreciated that exemplary systems 900 and 1100 can have more than one processor or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer implemented method, comprising:
detecting that a portion of an electronic publication is associated with a first scroll direction different than a second scroll direction of the electronic publication; and
generating a scrollable table containing the portion of the electronic publication that is associated with the first scroll direction different than the second scroll direction, the scrollable table being configured to navigate through the portion in the preferred scroll direction, whereby the scrollable table is presented in place of the portion of content during presentation of the electronic publication on a client device.

2. The computer implemented method of claim 1, wherein the portion of the electronic publication is detected in real time while another portion of the electronic publication is being presented on a client device.

3. The computer implemented method of claim 1, wherein the scrollable table includes one or more icons to navigate the portion of the electronic publication.

4. The computer implemented method of claim 1, wherein the scrollable table is configured to receive a touch gesture to scroll in the first scroll direction.

5. The computer implemented method of claim 1, wherein the scrollable table snaps to a display area of a client device when scrolling stops within the portion of the electronic publication.

6. The computer implemented method of claim 1, wherein generating the scrollable portion includes reformatting the portion according to a display area of a client device.

7. The computer implemented method of claim 1, further comprising:
determining that the portion exceeds an amount of content that can be presented on a display area of the client device.

8. A non-transitory computer readable storage medium having instructions therein, which when executed by a machine, causes the machine to perform a method, the method comprising:
detecting that a portion of an electronic publication is associated with a first scroll direction different than a second scroll direction of the electronic publication; and
generating a scrollable table containing the portion of the electronic publication that is associated with the first scroll direction different than the second scroll direction, the scrollable table being configured to navigate through the portion in the first scroll direction, whereby the scrollable table is presented in place of the portion of content during presentation of the electronic publication on a client device.

9. The non-transitory computer readable storage medium of claim 8, wherein the portion of the electronic publication is detected in real time while another portion of the electronic publication is being presented on a client device.

10. The non-transitory computer readable storage medium of claim 8, wherein the scrollable table includes one or more icons to navigate the portion of the electronic publication.

11. The non-transitory computer readable storage medium of claim 8, wherein the scrollable table is configured to receive a touch gesture to scroll in the first scroll direction.

12. The non-transitory computer readable storage medium of claim 8, wherein the scrollable table snaps to a display area of a client device when scrolling stops within the portion of the electronic publication.

13. The non-transitory computer readable storage medium of claim 8, wherein generating the scrollable portion includes reformatting the portion according to a display area of a client device.

14. The non-transitory computer readable storage medium of claim 8, further comprising:
determining that the portion exceeds an amount of content that can be presented on a display area of the client device.

15. A computer implemented method comprising:
detecting that a portion of an electronic publication is associated with a first scroll direction different than a second scroll direction of the electronic publication;
determining whether the portion can be presented on a display area of a client device; and
paginating the portion based on the determination, the paginated portion being configured to scroll in the second scroll direction.

16. The computer implemented method of claim 15, wherein the portion of the electronic publication is detected in real time while another portion of the electronic publication is being presented on a client device.

17. The computer implemented method of claim 15, wherein paginating the portion includes generating one or more pages of content from the portion according to the resolution of the display area of the client device.

18. The computer implemented method of claim 17, wherein the one or more pages are configured to snap to the display area when scrolling stops with a majority of a page being presented on the display area.

19. A non-transitory computer readable storage medium having instructions therein, which when executed by a machine, causes the machine to perform a method, the method comprising:
detecting that a portion of an electronic publication is associated with a first scroll direction different than a second scroll direction of the electronic publication;
determining whether the portion can be presented on a display area of a client device; and
paginating the portion based on the determination, the paginated portion being configured to scroll in the second scroll direction.

20. The non-transitory computer readable storage medium of claim 19, wherein the portion of the electronic publication is detected in real time while another portion of the electronic publication is being presented on a client device.

21. The non-transitory computer readable storage medium of claim 19, wherein paginating the portion includes generating one or more pages of content from the portion according to the resolution of the display area of the client device.

22. The non-transitory computer readable storage medium of claim 21, wherein the one or more pages are configured to snap to the display area when scrolling stops with a majority of a page being presented on the display area.
